(19) United States
(12) Patent Application Publication
(10) Pub. No.: US 2005/0022129 A1
(43) Pub. Date: Jan. 27, 2005

(54) Method for managing tree representations in graphical user interfaces

(75) Inventors: Howard Borenstein, Downsview (CA); Uliyana Markova, Toronto (CA); Lev Mirlas, Thornhill (CA); Glen Shortliffe, Toronto (CA)

Correspondence Address: Jeffrey S. LaBaw;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/756,142

(22) Filed: Jan. 13, 2004

(30) Foreign Application Priority Data
Jun. 17, 2003 (CA) 2432631

(51) Int. Cl. G09G 5/00

(52) U.S. Cl. 715/734

(57) ABSTRACT

A method for managing tree representations in graphical user interfaces. Tree representations used in this method have a plurality of nodes. Each node has a first and second node setting. Decision points in the tree representation are identified and a first visual indicator is displayed near decision points in the tree representation.

### FIELD OF THE INVENTION

The present invention relates to graphical user interfaces, and more particularly to a method for managing tree representations in graphical user interfaces.

### BACKGROUND OF THE INVENTION

Most modern operating systems and application programs are accessed by users through a graphical user interface. Examples of such operating systems are OS/2™ from IBM and Windows™ from Microsoft Corporation, and example applications include Microsoft Windows Explorer™, and Microsoft Word™.

A wide variety of operating systems and computer application programs incorporate, display and/or perform operations on data or information which is hierarchical in nature. For example, numerous computer operating systems and application programs provide users with access to a hierarchy of directories and sub-directories where documents, programs, e-mail messages and other information are stored. Similarly, organizer applications allow a user to establish task listings which are often hierarchical in nature.

Graphical user interfaces are often used to display such hierarchical information or data to the user in a “tree representation.” These tree representations visually indicate the level in the hierarchy where each item of data resides, and may allow a user to “expand” or “collapse” the tree at various points (i.e., displaying or hiding information in the lower levels) to facilitate a user's viewing of the hierarchical data. Each entry or item in the tree is referred to as a node.

A wide variety of computer programs are known in the art for providing a “tree navigator” graphical user interface to the user. A tree navigator graphical user interface is a graphical user interface that displays (and possibly allows for manipulation of) hierarchical data in a tree representation.

As the use of such tree navigator graphical user interfaces has expanded, so has the complexity of many of the hierarchical data sets that are provided to the user in the tree representation. For example, hierarchical data sets having thousands of branches are now common, and this data is often stored on multiple, geographically dispersed network servers. In some applications, it is desirable to allow the users of tree navigator graphical user interfaces to set and/or modify the settings and behaviors of one or more nodes, or entire sub-trees in the tree representation. For example, in applications where a tree representation is used to represent a merchandise catalog for an online store having a hierarchy of categories, products and items, the user may desire to set a discount of 20% to an entire category, which means that all products and items in that category should be discounted by 20%. In other instances, the user may desire to mark an entire category as “not available in the online store”, which means that all products and items of that category should not be displayed in the online store. There are several known methods which allow a graphical user interface to support this functionality.

In a typical solution, the settings and/or behavior of each node in the tree representation is defined by user-defined settings only. Node setting data is persisted for every node in the tree representation (i.e. every node in the tree has a data structure describing its settings). From a graphical user interface perspective, there are two ways the user can change the settings of a whole sub-tree: (1) by selecting each individual node in the sub-tree and changing its setting; or (2) by selecting the whole sub-tree and applying the settings to all nodes.

A disadvantage of these solutions is that they introduce data proliferation and redundancy as each node requires a separate copy of its settings. These solutions also create problems of data management and data consistency. For example, if you have a catalog tree with 10,000 product nodes and all of them are 10% off, then you would have to save 10,000 settings all with the same value. Overall, the typical solution is inefficient. A further drawback of the first approach is flawed usability which requires the user to perform a repetitive, tedious, highly laborious, and error-prone activity of manually changing the settings of each individual node.

A further drawback of known tree navigator graphical user interfaces is that these interfaces do not provide the user with an indication of the current node settings, which node settings in the tree representation have been set or modified by users, or how the current node settings have been defined.

In view of these shortcomings, there exists a need for an improved method for managing node settings of tree representations in graphical user interfaces.

### SUMMARY OF THE INVENTION

The present invention provides a method for managing tree representations in graphical user interfaces that indicates decision points in the tree representation where node settings have been defined as well as current node settings.

In accordance with one aspect of the present invention, there is provided for a data processing system, a method for managing a tree representation in a graphical user interface, the tree representation comprising a number of nodes, each node having a first and second node setting, the data processing system being operatively coupled to a display, the method comprises the steps of: displaying a tree representation; identifying decision points in the tree representation; and displaying a first visual indicator near decision points in the tree representation.

In accordance with another aspect of the present invention, there is provided a computer program product having a computer readable medium tangibly embodying code for directing a data processing system to manage a tree representation in a graphical user interface, the tree representation comprising a number of nodes, each node having a first and second node setting, the data processing system being operatively coupled to a display, the computer program product comprises: code for displaying a tree representation; code for identifying decision points in the tree representation; and code for displaying a first visual indicator near decision points in the tree representation.

In accordance with a further aspect of the present invention, there is provided a data processing system for managing a tree representation in a graphical user interface, the tree representation comprising a number of nodes, each node having a first and second node setting, the data processing system being operatively coupled to a display, the data processing system comprises: a tree view display controller for displaying a tree representation; a module for identifying decision points in the tree representation; and a module for displaying a first visual indicator near decision points in the tree representation.

In accordance with yet a further aspect of the present invention, there is provided a computer data signal embodied in a carrier wave for directing a data processing system to manage a tree representation in a graphical user interface, the tree representation comprising a number of nodes, each node having a first and second node setting, the data processing system being operatively coupled to a display, the computer data signal comprises code for: displaying a tree representation; identifying decision points in the tree representation; and displaying a first visual indicator near decision points in the tree representation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 is a schematic diagram of a computer system suitable for practicing the present invention;

FIG. 2 is a schematic diagram of a server for the computer system of FIG. 1 and which is connected to the computer system;

FIG. 3 is a schematic diagram of data arranged in a tree representation;

FIG. 4 is a block diagram of a data processing for the computer system of FIG. 1;

FIG. 5 is a block diagram of an embodiment for implementing a tree navigator graphical user interface according to the present invention;

FIG. 6 is a flowchart of the operation of a catalog filter implemented according to the present invention;

FIG. 7 is a screen capture of an example implementation of a catalog filter tree representation according to the present invention;

FIG. 8 is a flowchart of the initialization procedure of the catalog filter of FIG. 6;

FIG. 9 is a flowchart of the node expansion procedure of the catalog filter of FIG. 6;

FIG. 10 is a flowchart of the filter procedure of the catalog filter of FIG. 6;

FIG. 11 is a screen capture of a first use case example implementation of a catalog filter according to the present invention;

FIGS. 12 and 13 are screen captures of a second use case of a catalog filter according to the present invention;

FIGS. 13 to 17 are screen captures of a third use case of a catalog filter according to the present invention;

FIGS. 18 and 19 are screen captures of a fourth use case of a catalog filter according to the present invention; and

FIGS. 20 and 21 are screen captures of a fifth use case of a catalog filter according to the present invention.

Similar references are used in different figures to denote similar components.

### DETAILED DESCRIPTION OF THE DRAWINGS

The following detailed description of specific embodiments of the present invention does not limit the implementation of the invention to any particular computer programming language. The present invention may be implemented in any computer programming language provided that the operating system provides the facilities to support the requirements of the present invention. In one embodiment, the present invention is implemented, at least partly, in the Java computer programming language. Any limitations presented herein as a result of a particular type of operating system or computer programming language are not intended as limitations of the present invention.

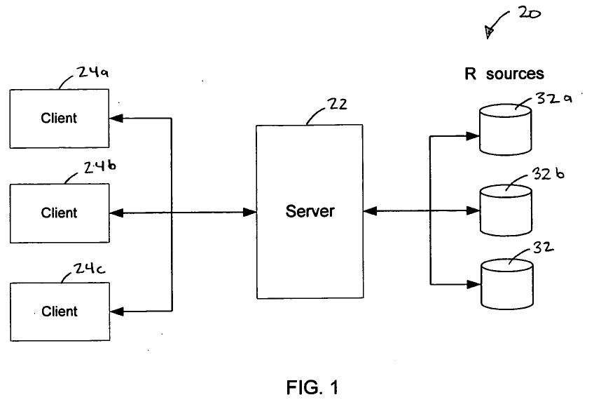

Reference is first made to FIG. 1, which shows a computer system 20 upon which the present invention may be implemented. The computer system 20 includes a server 22 and clients 24 which are interconnected by a network 30. The server 22 may be modeled as a number of server components including an application or business logic server, graphical user interface (GUI) server, and a database server or resource manager. The clients 24, indicated individually by references 24a, 24b, 24c, may be computers, data processing systems, handheld portable devices, or computer networks. The clients 24 may be the same or different. In one embodiment, the network 30 may be the Internet or World Wide Web (WWW). In such cases, the client computers 24 may be equipped with appropriate web browser software such as Internet Explorer™ from Microsoft Corporation or Netscape's Navigator™, and the application servers 22 are equipped with appropriate hyper text transfer protocol (HTTP) server software, such as the WebSphere™ product from IBM.

The computer system 20 further includes resources 32 connected to the network 30. The resources 32, indicated individually by references 32a, 32b, 32c, may be storage media, data stores, databases, and backend systems. The interface between the server 22 and the resources 32 may be a local area network, Internet, or a proprietary interface. The resources 32 may be accessed by the server 22 and the clients 24. Any of the server 22, the clients 24, and the resources 32 may be located remotely from one another or may share a location. The configuration of the computer system 20 is not intended as a limitation of the present invention, as will be understood by those of ordinary skill in the art from a review of the following detailed description. For example, although the network 30 is described as the Internet or WWW, the network 30 may also comprise a wireless link, a telephone communication, radio communication, or computer network (e.g. a Local Area Network (LAN) or a Wide Area Network (WAN)).

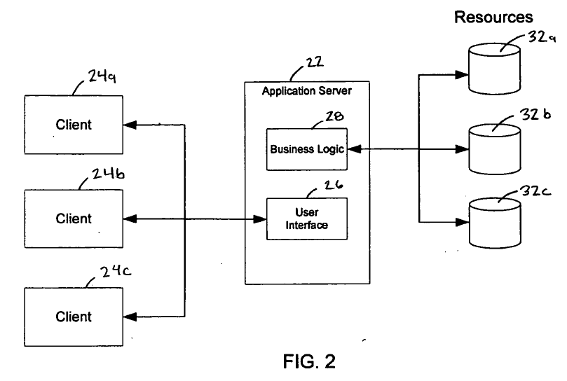

Referring now to FIG. 2, an implementation of the server 22 in the computer system 20 will be described in more detail. Preferably, the server 22 uses a web application server compliant with the Java Version 2 Enterprise Edition (J2EE) platform such as the WebSphere™ product from IBM. Clients 24 connect to the server 22 via the Internet or WWW. A user interface 26 is presented to a client 24, preferably using JavaServer Pages (JSPs) and servlets. Using JSP technology makes it easy for user interface developers to present dynamically generated pages to any client equipped with an Internet browser. Servlets give more sophisticated developers of Java-based applications the ability to implement dynamic presentations completely in the Java programming language. A business logic module or component 28 is implemented on the server 22 using Enterprise JavaBean components (EJB). WebSphere™ and other J2EE-compliant application servers provide an organization that allows the user interface functions 26 to be separated from the business logic 28 on the application server 22. Those skilled in the art will recognize that many computing platforms, operating systems, and enterprise application server suites may be used with the present invention without departing from the scope of the invention.

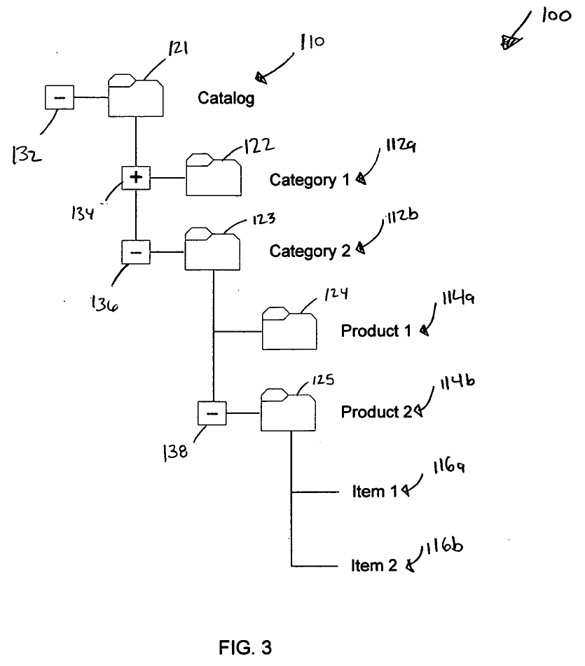

Reference is made to FIG. 3, an exemplary tree representation 100 of a hierarchical set of data or information that may be displayed using a tree navigator graphical user interface. The tree representation or tree 100 represents part of a product catalog comprised of a hierarchical structure of categories, products and items. The tree 100 is preferably displayed in an Internet browser on the client computer 24. The tree 100 comprises a plurality of nodes, 110, 112a, 112b, 114a, 114b, 116a, and 116b, at a variety of different levels. The catalog node 110 is the highest node in the tree 100. Each level of the tree 100 includes one or more nodes. Many nodes in the tree 100 have a parent-child relationship. Conventionally, nodes directly below a node in a higher level are referred to as “children” or “child nodes” of the higher “parent node”. For example, nodes 112a and 112b are child nodes of parent node 110. Each node has associated information that is displayed in the tree representation such as a label, e.g. the label “Category 1” for node 112a, and in some instances an icon, indicated by references 121, 122, 123, 124, and 125. Those of skill in the art will appreciate that the tree representation need not be displayed right to left across the page, and instead, for example, could extend from the bottom of the page to the top or from the top of the page to the bottom. It will also be appreciated that a wide variety of different types of data can be represented in a tree representation, and that the concepts of the present invention are not limited by the type of hierarchical data.

The user of a tree navigator graphical user interface will often desire access to nodes and associated data that are not currently displayed. The user may request that data be loaded by “expanding” a branch of the tree representation. When nodes in the tree representation 100 have child nodes, a control button will be represented beside the node. Control buttons indicated by references 132, 134, 136, 138 comprise a box containing either a “+” or “−” sign. These control buttons, which are well known in the art, are referred to as “expand” (the “+” control button) or “collapse” (the “−” control button) control buttons which allow the user to either display or hide the child nodes and information contained in lower branches of the tree 100. Thus, for example, if the user selects (typically using a pointing device such as a mouse) the collapse control button 138, nodes 116a and 116b are hidden in the tree representation 100, and the control button 138 is replaced with an expand control button (which indicates to the user that additional, undisplayed child nodes exist below). Those of skill in the art will appreciate that numerous other methods exist by which a user can request that data be loaded into a tree navigator graphical user interface, for example, via commands entered through pull down menus, dialog boxes, or control panels.

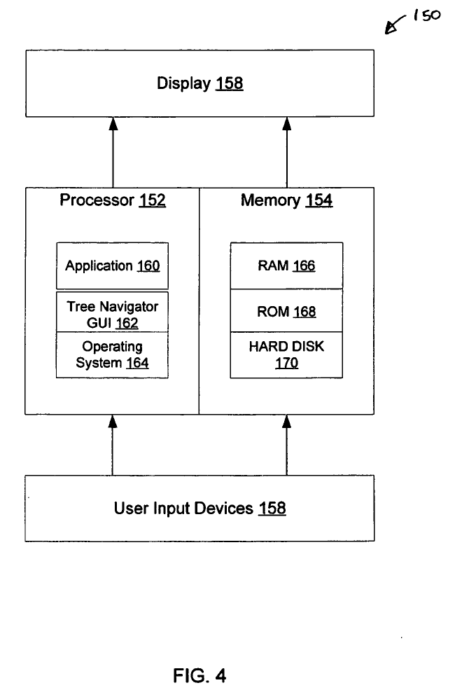

Reference is made to FIG. 4, which shows a data processing system 150 for the computer system 20. The data processing system 150 comprises a processor 152, a memory 154, a display 156, and user input devices 158 such as a keyboard and a pointing device (e.g. mouse), and a communication interface (not shown) for communicating with the network 30. A number of programs, indicated individually by references 160, 162 and 164, run on the processor 152 and include an operating system 164 and a tree navigator graphical user interface 162. The memory 154 includes random access memory (“RAM”) 166, read only memory (“ROM”) 168, and hard disk 170.

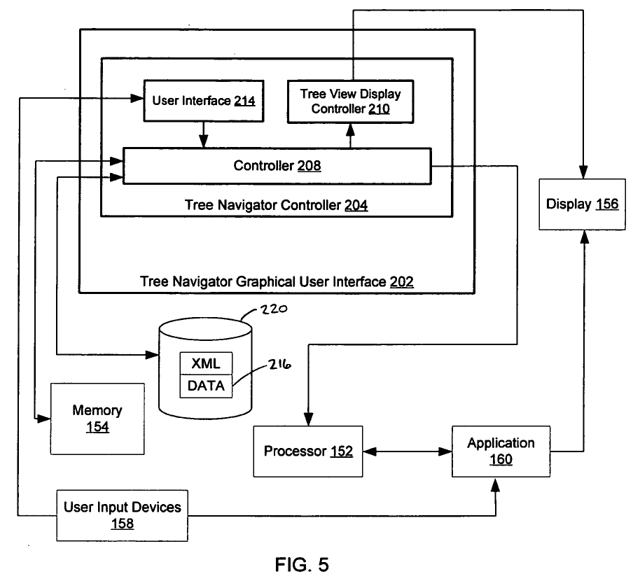

Reference is next made to FIG. 5, which shows an implementation for a tree navigator graphical user interface 202 according to one aspect of the present invention. The tree navigator graphical user interface 202 is implemented in functional modules in the form of computer software or a computer program product and executed by the processor 152 in the data processing system 150 (FIG. 4) during operation of the computer program product. The tree navigator graphical user interface 202 comprises a tree navigator controller 204 including a controller 208, a tree view display controller 210, and a user interface 214. The user accesses the user interface 214 through one or more user input devices 158 such as a pointing device or a keyboard. User commands or actions input from the user input devices 158 are received at the user interface 214 and sent to the controller 208.

In one embodiment, both the user interface 214 and the controller 208 are implemented as software modules. The processor 152 may be used to process user commands such as commands to load data, commands to navigate the display, commands to add, edit, move or delete data entered by the user via the user input devices 158. The controller 208 also interfaces with the tree view display controller 210 which is used to control how a tree view display is displayed on the display 156. In some embodiments, there may also be a data display controller (not shown) for controlling the display of associated data, for example, in a secondary display window such as that commonly used in file managers such as Windows™ Explorer. The controller 208 also has access to the memory 154 and a database 220 which may be located locally or remotely, for example, on a back-end server. The database 220 may comprise a relational database such as the DB2™ software product from IBM. A hierarchical data set 216 from which the tree representation is constructed is stored on the database 220.

The tree view display controller 210 is coupled to the display device 156. Through this connection the tree navigator graphical user interface 202 displays data in response to user inputs. The display device 156 may also be used to display data associated with other applications, such as the application 160. These other applications also use the processor 152 of the data processing system 150.

The present invention will now be explained further by way of examples implemented in a reseller marketplace such as that provided by the WebSphere™ Commerce product from IBM in a reseller marketplace, resellers may have online stores hosted on their manufacturer's website. In some applications, multiple resellers may access a manufacturer's reseller marketplace, often from remote, geographically dispersed locations. Reseller stores hosted in this manner typically have a hosted storefront served using the manufacturer's IT infrastructure. To support the hosted reseller storefront, the reseller marketplace may have a catalog filter to enable the reseller to configure products and pricing in the hosted store. The catalog filter allows resellers to select portions of a predefined manufacturer catalog that are to be made available for sale in their online store. Using the catalog filter, a reseller can decide to include or exclude for sale specific categories and products. This is also referred to as setting up product entitlement. While configuring entitlement, the reseller may simultaneously specify a percentage price markup or markdown based on the manufacturer's specified list price. This operation is known as “discounting” or “setting price adjustments” in the catalog.

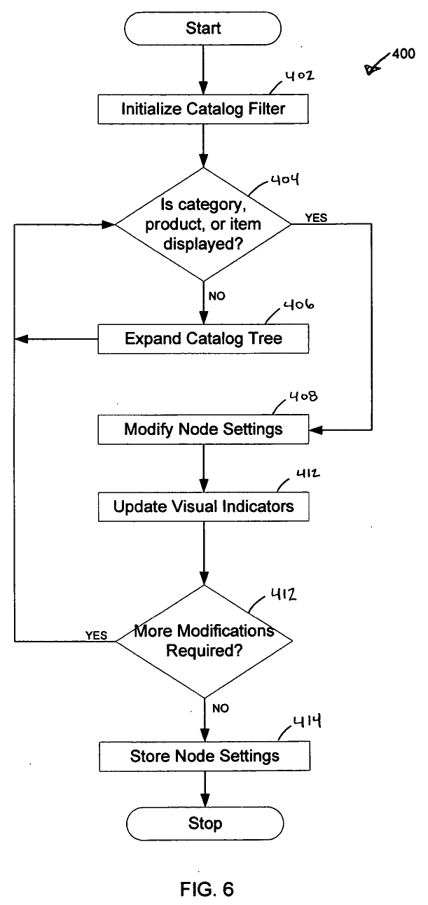

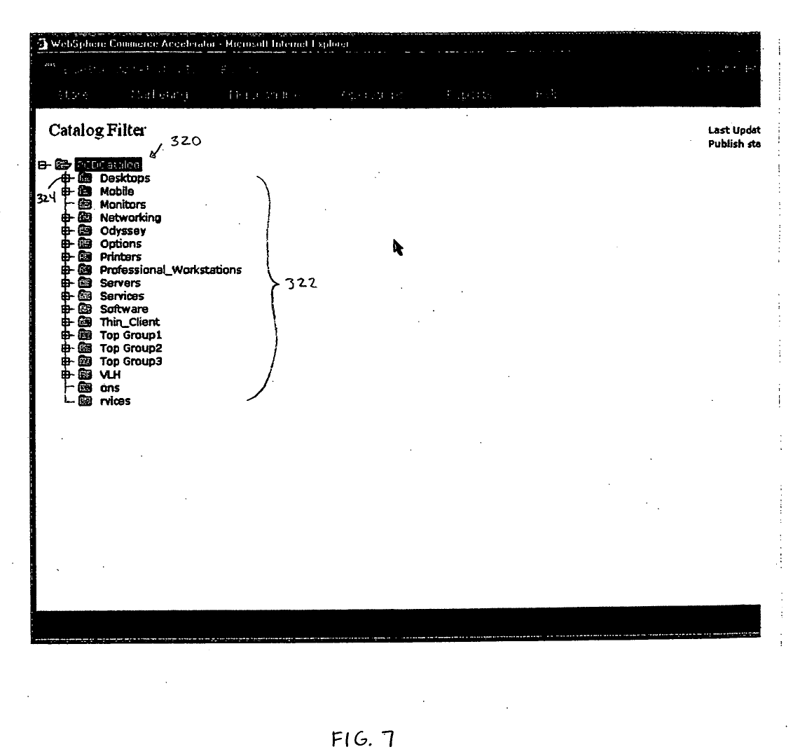

Reference is made to FIGS. 6 and 7, which show by way of example a catalog filter implemented using a tree navigator graphical user interface according to the present invention. FIG. 6 shows in flowchart form a process 400 for operating a catalog filter according to the present invention. FIG. 7 is a screen shot of a catalog filter tree 320 implemented according to the present invention. In this example, the catalog filter tree 320 is represented as a hierarchical tree of categories, products, packages and items corresponding to a manufacturer catalog. Other catalog structures and arrangements are possible. As will be explained more fully below, each node in the catalog filter tree 320 has an implicit setting inherited from its parent node. The implicit setting may be overridden by an explicit setting defined by the user. The explicit setting will then be inherited by any child nodes with an implicit setting (i.e. not having their own explicit setting). This explicit setting may be cancelled by the user, thereby returning the node and affected child nodes to their implicit or inherited state.

As shown in FIG. 6, the first step 402 in the catalog filter process 400 comprises the user initializing the catalog filter. Upon initialization of a session the top level node representing the catalog filter tree 320 and the top level categories 322 are loaded by the controller 208. Initially, there are no user defined settings in the tree 320. Optionally, the whole tree 320 may be set initially to an initial default setting applied to the top level catalog node. Each node in the catalog filter tree 320 has an associated context-sensitive menu that provides information about the node such as the actions or options that are available. Upon initialization, the desired category, product, package or item may not be displayed (decision block 404). If the category, product, package or item of interest to the user is not currently displayed, the user can expand the nodes in the catalog filter tree 320 so that child nodes are displayed (step 406). The user interface allows the user to expand the nodes in several ways. Typically, the user will use a pointing device to click on the control button, for example control button 324, corresponding to the node which is to be expanded. Alternatively, a user using a mouse or similar pointing device may click on the node to be expanded to “pop up” the context-sensitive menu associated with the node and select “Expand” from the available actions or menu options. Other methods of expanding nodes may also be used. As shown in FIG. 6, steps 404 to 406 are repeated until the desired category, product, package or item is displayed.

Once the desired category, product, package or item is displayed, the user may then modify the settings associated with the category, product, package or item (step 408). The available settings are described in more detail below and are shown in Table 1. When the user modifies node settings, for example, by changing entitlement or setting a price adjustment, this is referred to as a filter. Each filter has corresponding filter settings (sometimes referred to as node settings). The user uses a pointing device such as a mouse and clicks on the desired node to bring up the context-sensitive menu associated with the node and corresponding to the desired category, product, package or item. The user can then modify the node settings using the actions or menu options available in the context-sensitive menu. The catalog filter tree is next updated to reflect changes in the node settings by updating visual indicators such as node icons and labels (step 410). If more modifications to node settings are desired, steps 404 to 410 are repeated as required (decision block 412). If no further modifications are desired, the changes to the node settings are stored in the database 220 (step 414).

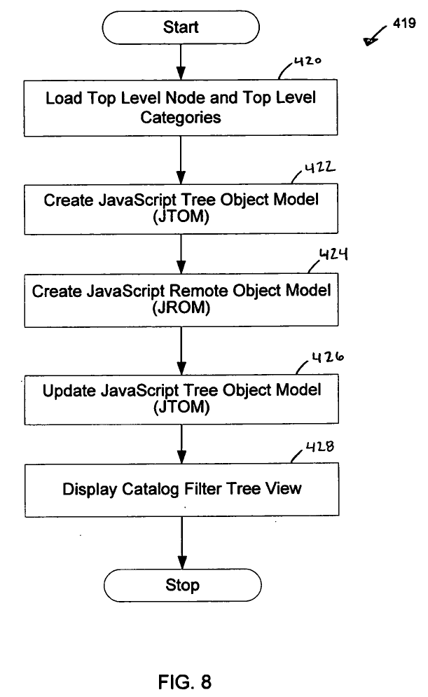

Reference is next made to FIG. 8, which shows in more detail the process steps for the initialization procedure 402 (FIG. 6) for the catalog filter, indicated generally by reference 419. When the catalog filter is initialized, the controller 208 (FIG. 5) loads data from the hierarchical data set 216 (FIG. 5) representing the top level node 320 and the top level categories 322 as indicated in step 420. An object is then created for each node in the catalog filter tree and stored in a JavaScript object model called the JavaScript Tree Object Model (JTOM) (step 422). The JTOM is a hierarchical object model representing the entire tree structure as rendered in the client browser and where each object in the data structure is aware of its parent. Each time a tree node is expanded, a server request is sent to download the child node information and a new object corresponding to each new child node is created in the JTOM. Hence, the JTOM is dynamic and grows to reflect these new children. Each time the JTOM is changed (i.e. a node is expanded or collapsed), the catalog filter tree is redrawn to reflect the changes. For each node, the JTOM includes information about its node ID, its parent node ID, the list of displayed icons, the text label(s) displayed, and the actions or menu options that are available for that node.

Next in step 424, the controller 208 (FIG. 5) loads any previous catalog filter settings. Typically, if a node does not have existing filter settings, for example, when the catalog filter is used for the first time, the node will be undefined or have the initial settings specified by the catalog filter. For example, nodes in the catalog filter may have an initial or default adjustment of “+0%””. In one embodiment, the previous catalog filter settings are loaded from the database 220 (FIG. 5) in XML (eXtensible Markup Language) format by a Java databean called PriceTCMasterCatalogWithFilteringDataBean. The databean converts the XML string representation of catalog filter settings into a vector of catalog filter databeans (called CatalogFilterDataBean). A server side JSP (JavaServer Page) called CatalogTree.jsp accesses the vector of databeans and coverts it into a client processable Javascript object model called the Javascript Remote Object Model (JROM). The JROM contains information on the filters currently defined, that are persisted in the database (e.g. from the last save) and active in the storefront. The JROM is static and generated only once during the initialization of the catalog filter. Each object in the JROM identifies a node in the catalog filter tree where the filter was applied (whether it is currently displayed or not) and the information for that filter. The filter information includes the node ID, a flag for inclusion or exclusion, and an adjustment value, if appropriate. Next in step 426, information regarding the node icons, text labels, and menu options are updated in the JTOM for each node affected by a filter in the JROM. Next in step 428, the controller 208 (FIG. 5) sends node information from the JTOM to the tree view display controller 210 (FIG. 5) which generates a JSP which updates the catalog filter tree view in the user's browser.

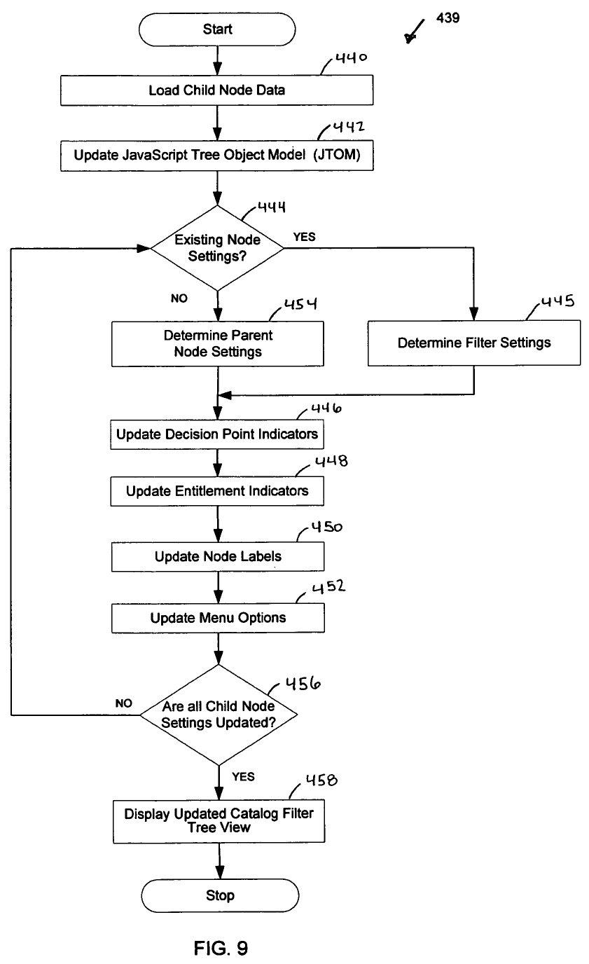

Reference is now made to FIG. 9, which shows in flowchart form a process 439 for node expansion of the catalog filter tree. When a user decides to expand a node in the catalog filter tree, the controller 208 (FIG. 5) loads data from the hierarchical data set 216 (FIG. 5) corresponding to the respective child nodes of the node to be expanded (step 440). The JTOM is then expanded to reflect the new child nodes (step 442). Next, a Javascript function is called to determine whether the downloaded child nodes have existing filter settings in the JROM. The lookup in the JROM is done by node ID. If the downloaded node ID exists in the JROM, than that node has a pre-existing filter setting defined (decision block 444). If a JROM setting is found, the node is said to have an “explicit” setting defined by the user. The filter settings of the node are then determined (step 445).

Next in step 446, the information regarding a decision point is updated (added, removed, or unchanged) in the JTOM. A decision point is a node in the catalog filter tree that has had an explicit filter setting defined by the user. A “blue dot” icon may serve as a visual indicator that the corresponding node is decision point. When an explicit setting exists, a “blue dot” icon is displayed. If an explicit setting does not exist (i.e. an implicit setting exists or a node is undefined) the “blue dot” icon is removed. Next in step 448, the entitlement icon information in the JTOM is updated to show inclusion or exclusion which will be represented by a checkmark or “X” respectively. In this example, the icons serve as a visual indicator of entitlement status. The text label information is then updated in the JTOM (step 450). Next in step 452, the context-sensitive menu options that are available for that node are updated in the JTOM. The context-sensitive menus are dynamically configured as shown in Table 1 below. Available actions depend on whether the node has been implicitly or explicitly set or undefined, the type of node (e.g. catalog or category), and the settings of the parent node, if any.

TABLE 1
Node State and Available Acti ns/Menu Opti ns

| Node Type | Included | Excluded | Undefined |
|---|---|---|---|
| Catalog | Set price adjustment | N/A (cannot exclude | Include |
| | Cancel filter | the catalog) | |
| Category | Set price adjustment | Cancel filter (unless | Include |
| | Exclude (unless parent | parent is undefined in | |
| | is undefined in which | which case this option | |
| | case this option is not | is not available) | |
| | available) | | |
| | Cancel filter (unless | | |
| | parent is undefined in | | |
| | which case this option | | |
| | is not available) | | |
| Product, | Set price adjustment | Cancel filter (unless | Include |
| package, | Exclude (unless parent | parent is undefined in | |
| item | is undefined in which | which case this option | |
| | case this option is not | is not available) | |
| | available) | | |
| | Calculate price | | |
| | Cancel filter | | |

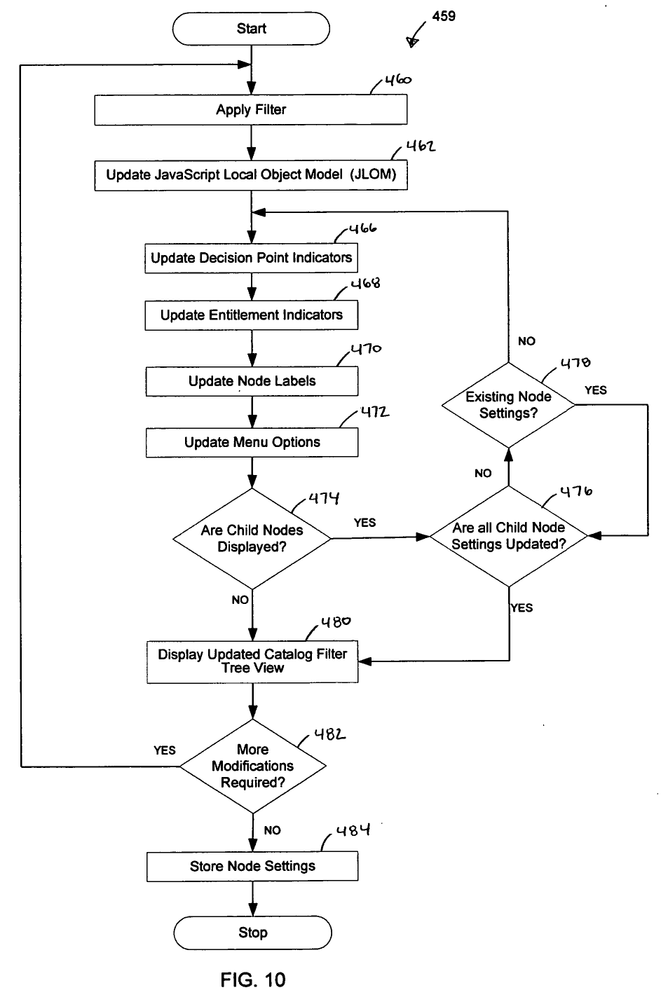

Referring still to FIG. 9, if a JROM setting is not found, than the downloaded child node has no explicit setting and is deemed to have an implicit setting based on its parent information (step 452). Nodes of this type are said to have an “implicit” setting. An implicit node inherits the properties and settings of its parent node including its icons, menu options, and adjustment label, if any. In step 454, the settings of the node's immediate parent node is first determined. This information is fetched from the JTOM using the parent node ID. The information regarding the node icons, text labels, and menu options are then updated in the JTOM as indicated in steps 446 to 452. If other child nodes require updating as determined in decision block 456, the operations according to steps 444 to 452 are repeated. When all child node objects have been updated in the JTOM, the controller 208 (FIG. 5) sends node information from the JTOM to the tree view display controller 210 (FIG. 5) which generates a JSP which updates the catalog filter tree view in the user's browser (step 458). Reference is next made to FIG. 10, which shows in flowchart form the process steps for a filter procedure 459 of the catalog filter. In the first step 460, the user applies a filter or modifies the filter settings of a node in the catalog filter tree. The user has a pointing device such as a mouse and clicks on the desired node to bring up the context-sensitive menu associated with that node. The user can then modify the filter node settings using the actions available in the context-sensitive menu. When an action is performed (e.g. a filter is added, deleted, or modified), a filter object is defined and stored in a Javascript object model called the Javascript Local Object Model (JLOM) (step 462). The JLOM resides locally on the client system and may be defined in memory 154 (FIG. 5). The JLOM effectively represents the new filters the user has defined in the current session and that have not yet been persisted to the database. Thus, the JLOM is empty at the start of each session. Each object in the JLOM contains information about the filter settings applied in the current session, including node ID, a flag for inclusion or exclusion, an adjustment value, if appropriate.

Next, a Javascript function is called to update the icons, labels, and menu options information for affected objects in the JTOM. Using the filter settings, the information regarding the decision point icon is managed (added, removed, or unchanged) to reflect any change in the explicit or implicit status of the node (step 466). Next in step 468, the icon information in the JTOM is managed to update any changes in entitlement status (e.g. inclusion or exclusion). If an adjustment has been made, the label text is updated in the JTOM to reflect the new adjustment value (step 470). Next in step 472, the context-sensitive menu options that are available for the node are updated in the JTOM.

A lookup is then performed on the JTOM to identify child nodes of the changed node (decision block 474). If child nodes are identified, the icons, labels, and menu options are updated by repeating steps 466 to 472 for each child node with implicit settings (decision blocks 476 and 478). Child nodes with explicit settings do not require updating in the JTOM as those settings will not change. When all affected child nodes have been updated, the controller 208 (FIG. 5) sends node information from the JTOM to the tree view display controller 210 (FIG. 5) which generates a JSP which updates the catalog filter tree view in the user's browser (step 480).

The user may desire to further create or modify filter settings (decision block 482). If more modifications are desired, steps 460 to 478 are repeated as required. As indicated in step 484, if no more modifications are desired, the new filters defined in the current session are persisted in the database 220 (FIG. 5). When the user clicks “Save” or otherwise selects to store the current changes (e.g. by exiting the catalog filter), the Javascript objects in the JLOM are converted to XML and stored in the database 220 (FIG. 5). This approach mitigates problems of data proliferation and redundancy. When the catalog filter settings are saved, only the decision points are persisted. When the tree is reloaded in a new session, only the decision points are read and the tree is redrawn based on these points. Next, the server may publish the new filter settings to the storefront. In applications where the user is a reseller, publishing the new filter settings will update the catalog and pricing information which is published in the online store. In some embodiments, the manufacturer and possibly other resellers may then be able to access and view users' persisted filter settings in another session of the catalog filter. In some of these embodiments, the manufacturer may have supervisory access to a user's settings so that they may change product availability or override pricing information.

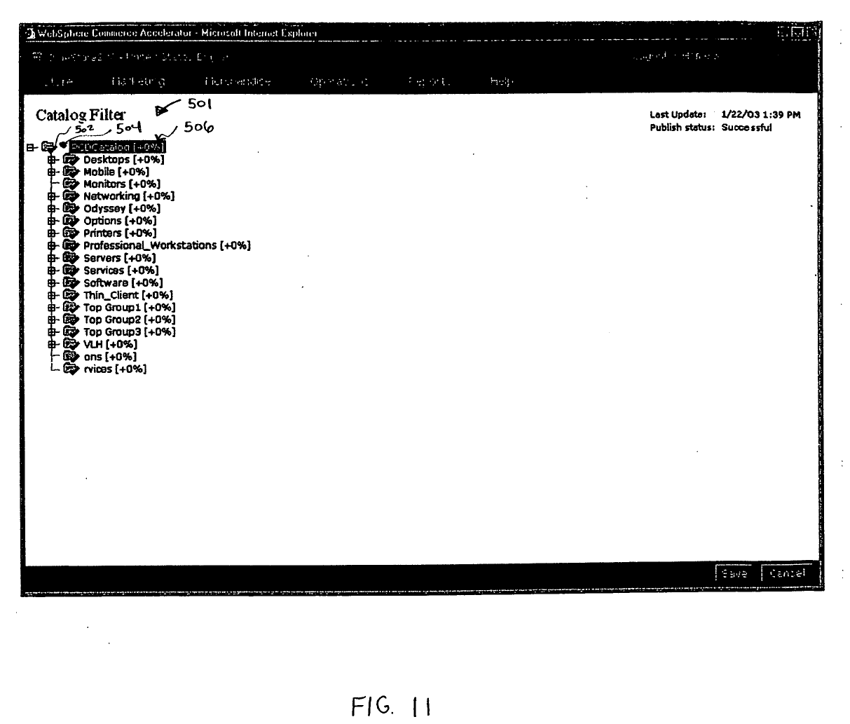

Reference is now made to FIG. 7 and FIG. 11, which show by way of example screen shots of a first use case of a catalog filter 501. In this case, the user includes (e.g. makes available for sale) the entire catalog. A price adjustment of 0% is applied by default. A green checkmark 502 appears by the catalog node “PCDCatalog” as shown in FIG. 11. A visual indicator (blue dot) 504 also appears next to the catalog node to indicate a decision-making point and show that the behavior of this node was explicitly set by the user. A “+0%” adjustment label 506 also appears next to the catalog node. In this example, none of the catalog child nodes have explicit settings. The implicit setting of the child nodes is now changed to the catalog's explicit setting and as a result they all receive a green checkmark.

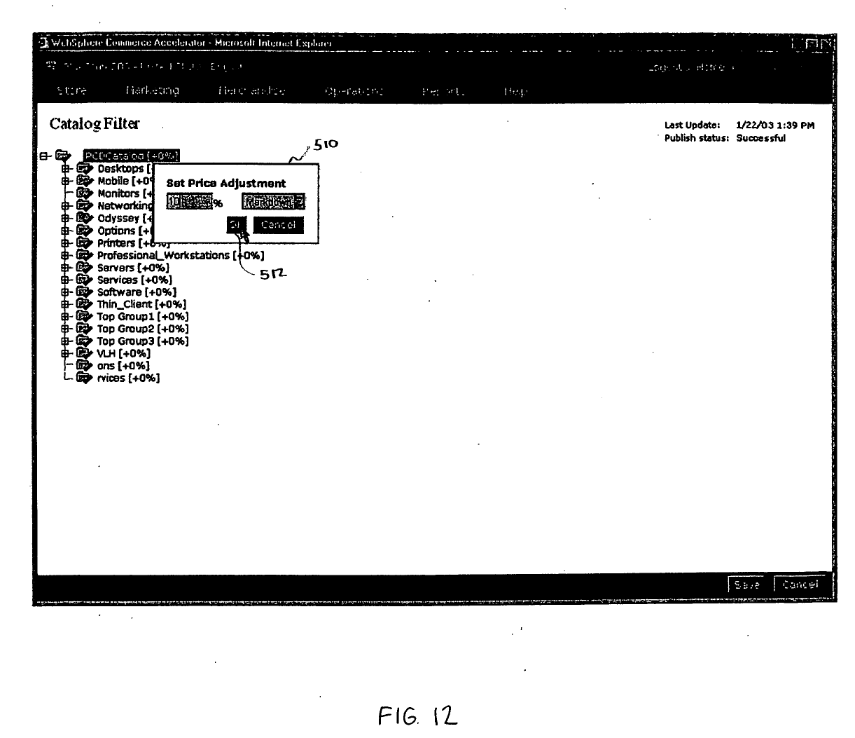

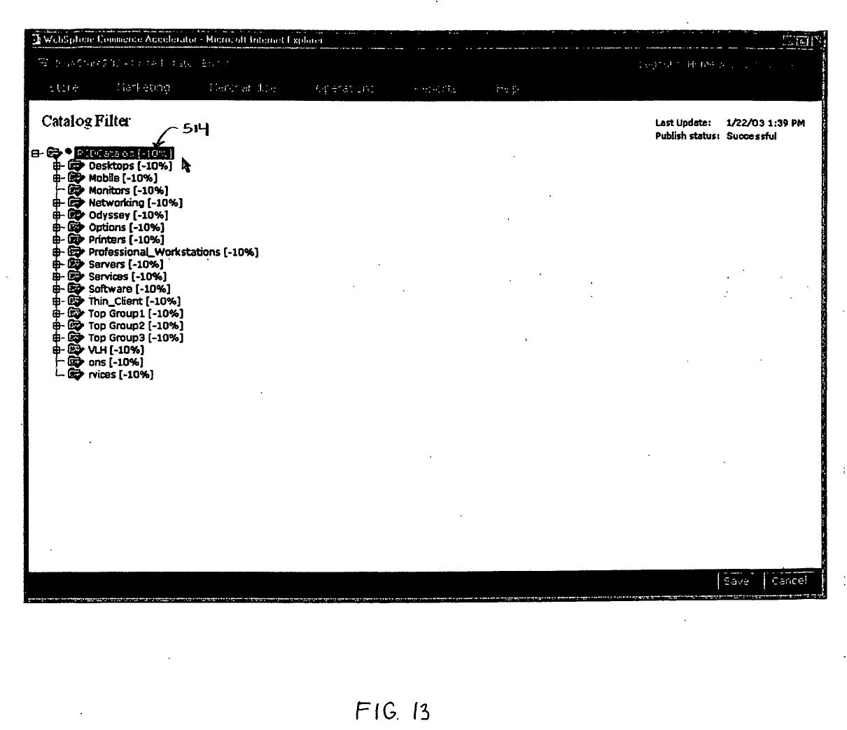

Reference is now made to FIGS. 12 and 13, which show by way of example screen shots of a second use case of a catalog filter. In this case, the user sets a “−10%” adjustment (markdown) on the entire catalog. When the user selects the catalog node, the context-sensitive menu associated with the catalog node will “pop up”. The user then clicks “Set Price Adjustment” on the context-sensitive menu which generates a pop-up dialog 510 as shown in FIG. 12. The user then enters a 10% markdown in the pop-up dialog 510, and clicks an “OK” control button 512. The entire tree is then redrawn to show the new adjustment labels, such as an “−10%” adjustment label 514 next to the catalog node (FIG. 13). The green checkmarks are not changed because entitlement has not been changed. Further, the visual indicator 504 (FIG. 12) does not change because an existing filter at the catalog node was modified.

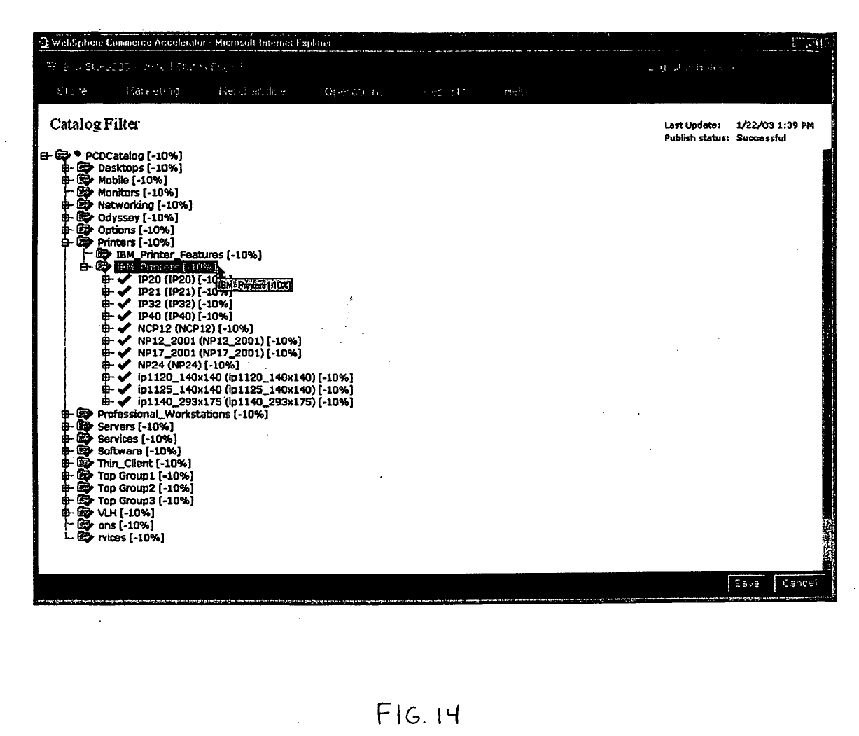

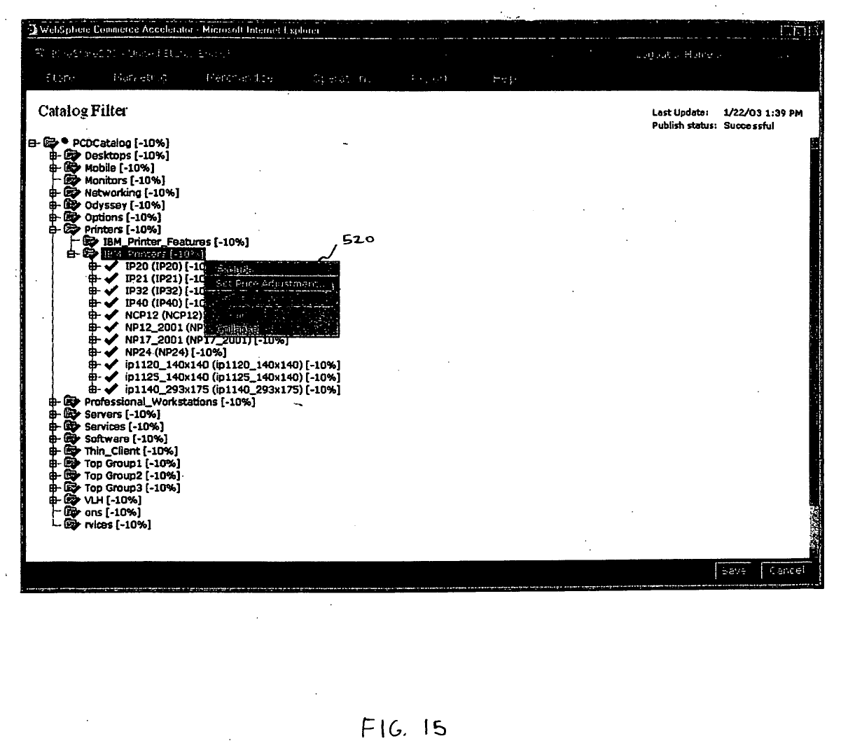

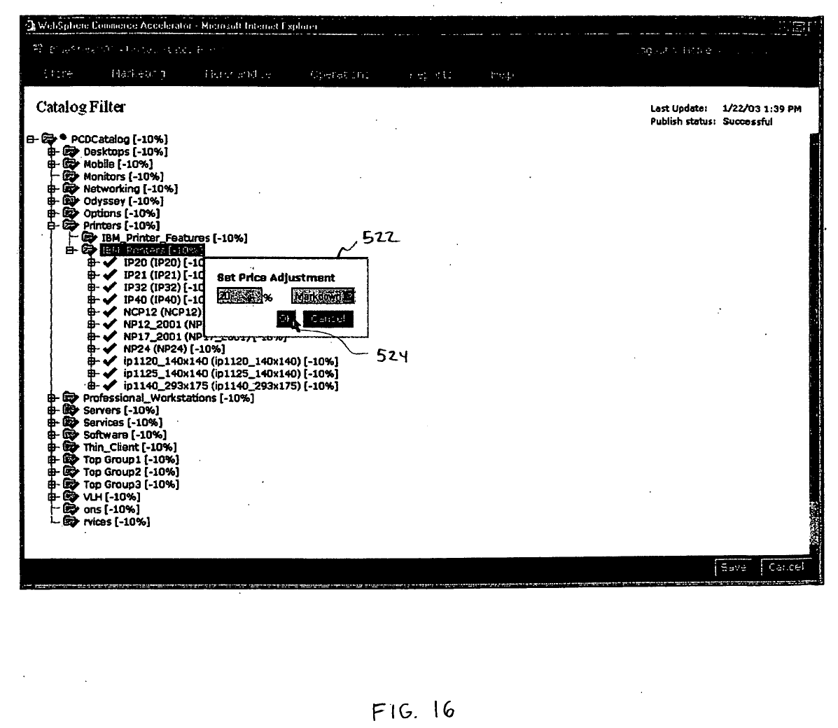

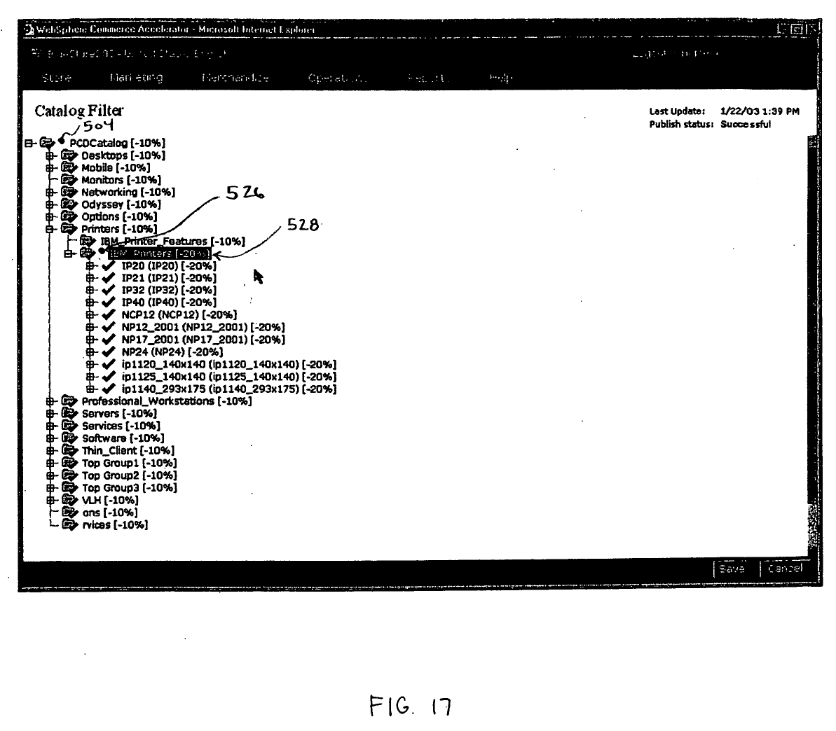

Reference is next made to FIG. 14 to 17, which show by way of example screen shots of a third use case of a catalog filter. In this case, the user sets a “−20%” adjustment (markdown) on a specific category. The user selects the “IBM_Printers” node and a context-sensitive menu 520 associated with the node “pops up” (FIG. 15). The user then clicks “Set Price Adjustment” on the context-sensitive menu 520 which generates a pop-up dialog 522 (FIG. 16). The user then enters a 20% markdown in the pop-up dialog 522, and clicks the “OK” control button 524. A visual indicator (blue dot) 526 is displayed next to the “IBM_Printers” node to indicate that the behavior of this node was explicitly set by the user (FIG. 17). The “IBM_Printers” node and its sub-tree is redrawn to show the new adjustment labels, such as the “−20%” adjustment label 528 next to the “IBM_Printers” node (FIG. 17). The green checkmarks are not changed because entitlement has not been changed. Further, the visual indicator 504 (FIG. 17) does not change because the associated filter is still applied. Product nodes can similarly be adjusted.

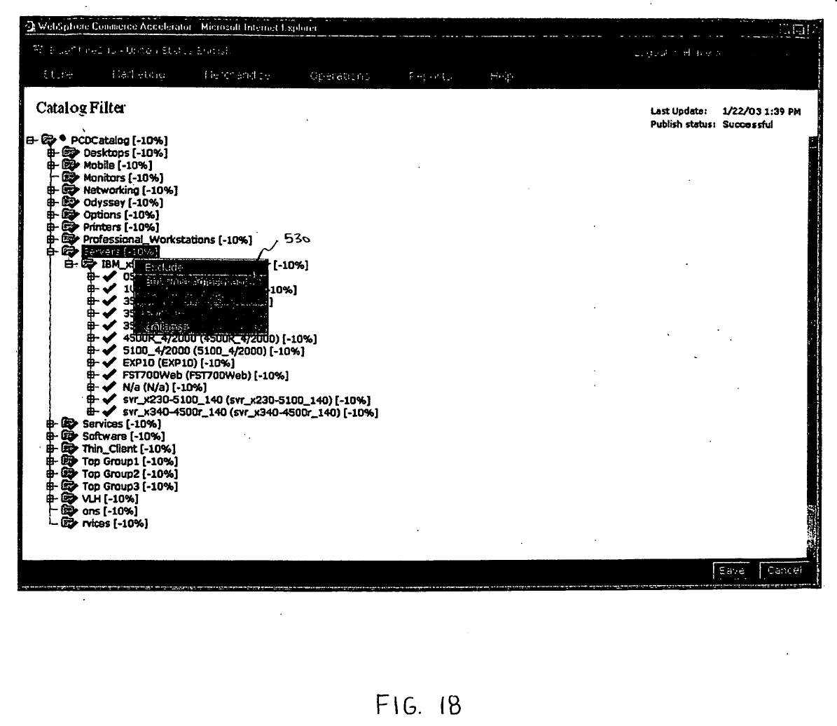

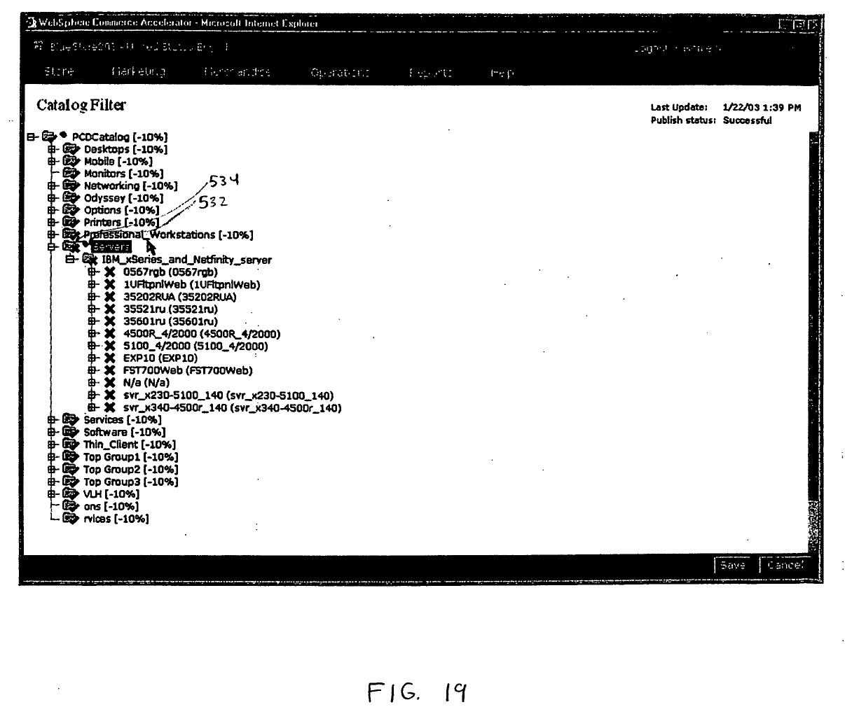

Reference is next made to FIGS. 18 and 19, which show by way of example screen shots of a fourth use case of a catalog filter. In this case, the user excludes a specific category. The user selects the “Servers” node and a context-sensitive menu 530 associated with the node “pops up” (FIG. 18). The user then clicks “Exclude” on the context-sensitive menu 530 which generates a pop-up dialog. A visual indicator (blue dot) 532 appears next to the “Servers” node to indicate that the behavior of this node was explicitly set by the user (FIG. 19). The “Servers” node and its sub-tree is redrawn to show the new entitlement values. A red “X” is displayed beside the effected nodes, such as icon 534 (FIG. 19) next to the “Servers” node. The adjustment labels are removed from the entire “Servers” category. Product nodes can similarly be excluded.

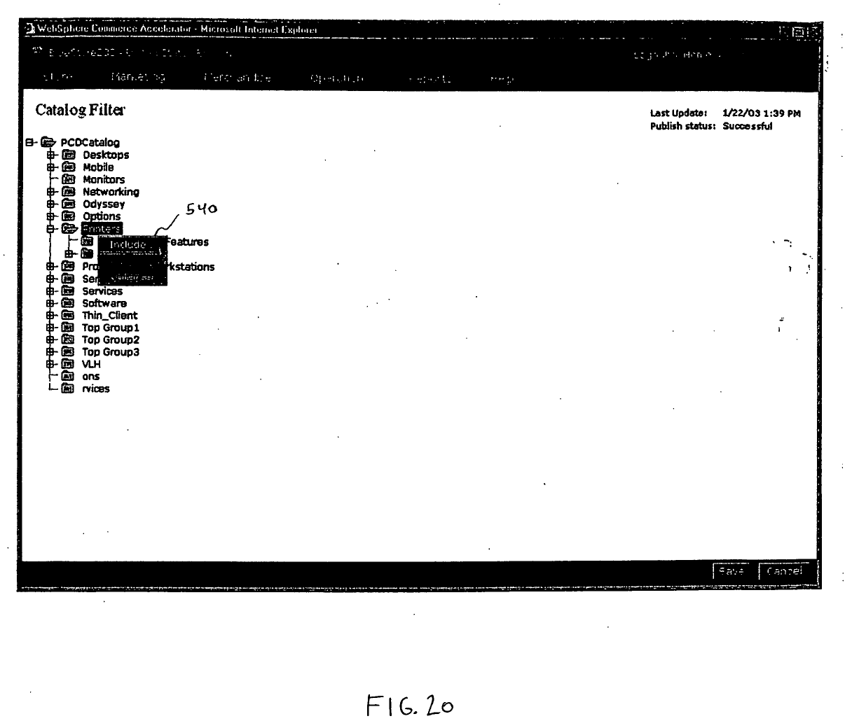

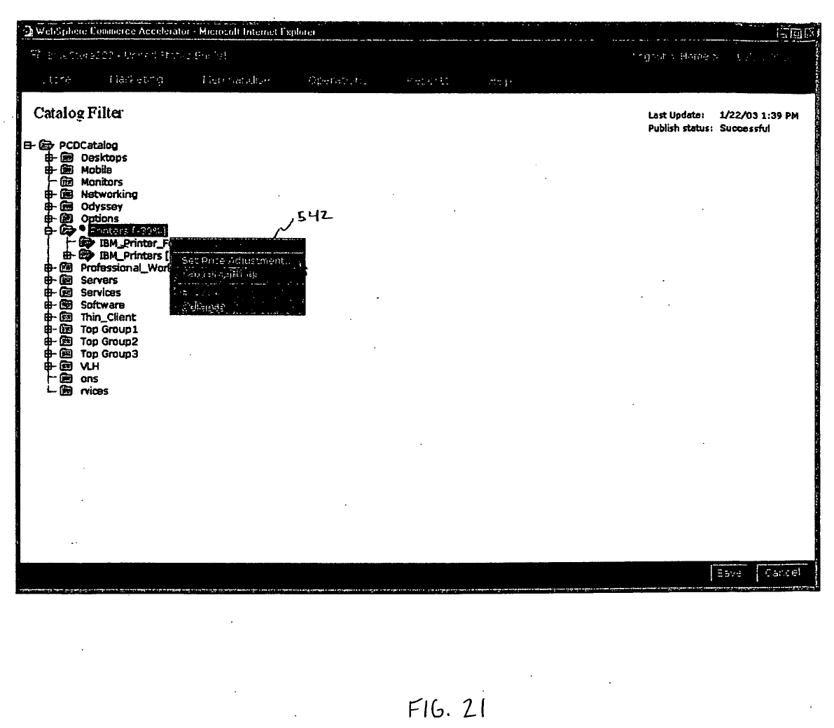

Reference is next made to FIGS. 20 and 21, which show by way of example screen shots of a fifth use case of a catalog filter. In this case, the user cancels explicit settings. FIG. 20 shows a catalog filter in which all nodes in the catalog filter tree are undefined. When the user clicks on the “Printers” node a context-sensitive menu 540 is displayed. The available actions are “Include” and “Collapse”. As shown in FIG. 21, when an explicit setting is given to the “Printer” category, in this case a “−30%” adjustment, a “Cancel Settings” option is added to the “Printers” node's context-sensitive menu 542. If the user selects “Cancel Settings” for the “Printers” node, the explicit settings of the node and all its child nodes will be cancelled in which case the “Printers” node and all its child nodes will assume their implicit state, i.e. the one inherited from their parent. The “Printers” category will then be redrawn to revert back to the image shown in FIG. 20, and the node's context-sensitive menu will revert back to its implicit definition.

Although the foregoing detailed description uses specific examples of a catalog filter to explain the present invention, those of ordinary skill in the art will appreciate that the present invention is not limited to catalog filters or electronic merchandise catalogs and may be implemented in other graphical user interfaces representing a hierarchical data structure where it may be desired to modify or switch between node states or settings.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

1. For a data processing system, a method for managing a tree representation in a graphical user interface, the tree representation comprising a plurality of nodes, each node having a first and second node setting, the data processing system being operatively coupled to a display, said method comprising the steps of:
displaying a tree representation;
identifying decision points in the tree representation; and
displaying a first visual indicator near decision points in the tree representation.

2. The method as claimed in claim 1, wherein said step of identifying decision points in the tree representation includes identifying nodes in said tree representation having an explicit user defined setting.

3. The method as claimed in claim 2, further comprising the steps of:
determining the status of said first node setting; and
displaying a second visual indicator corresponding to the status of said first node setting.

4. The method as claimed in claim 3, wherein the status of said first node setting is a first state or a second state.

5. The method as claimed in claim 3, wherein the status of said first node setting is include or exclude.

6. The method as claimed in claim 4, further comprising the steps of:
determining the value of said second node setting; and
displaying a third visual indicator corresponding to the value of said second node setting.

7. The method as claimed in claim 4, wherein said first and second visual indicators are icons displayed near the corresponding node.

8. The method as claimed in claim 4, wherein said first visual indicator is a blue dot icon, wherein said second visual indicator is a checkmark icon when the status of said first node setting corresponds to said first state, and wherein said second visual indicator is an “X” icon when the status of said first node setting corresponds to said second state.

9. The method as claimed in claim 6, wherein said third visual indicator is a text label displayed near the corresponding node.

10. The method as claimed in claim 1, wherein the plurality of nodes are arranged in a hierarchical structure of nodes, said hierarchical structure comprising a plurality of levels including at least one parent level and at least one child level, wherein said hierarchical structure includes a node setting inheritance scheme, and wherein a node in said one child level inherits the node settings of a node in said one parent level.

11. The method as claimed in claim 10, wherein said inherited settings can be overridden by an explicit setting defined by a user of the data processing system.

12. A computer program product having a computer readable medium tangibly embodying code for directing a data processing system to manage a tree representation in a graphical user interface, the tree representation comprising a plurality of nodes, each node having a first and second node setting, the data processing system being operatively coupled to a display, said computer program product comprising:
code for displaying a tree representation;
code for identifying decision points in the tree representation; and
code for displaying a first visual indicator near decision points in the tree representation.

13. The computer program product as claimed in claim 12, wherein said code for identifying decision points in the tree representation includes code for identifying nodes in said tree representation having an explicit user defined setting.

14. The computer program product as claimed in claim 13, further comprising:
code for determining the status of said first node setting; and
code for displaying a second visual indicator corresponding to the status of said first node setting.

15. The computer program product as claimed in claim 14, further comprising:
code for determining the value of said second node setting; and
code for displaying a third visual indicator corresponding to the value of said second node setting.

16. The computer program product as claimed in claim 12, wherein the plurality of nodes are arranged in a hierarchical structure, said hierarchical structure comprising a plurality of levels including at least one parent level and at least one child level, wherein said hierarchical structure includes a node setting inheritance scheme, and wherein a node in said one child level inherits the node settings of a node in said one parent level.

17. The computer program product as claimed in claim 16, wherein said inherited settings can be overridden by an explicit setting defined by a user of the data processing system.

18. A data processing system for managing a tree representation in a graphical user interface, the tree representation comprising a plurality of nodes, each node having a first and second node setting, said data processing system being operatively coupled to a display, said data processing system comprising:
a tree view display controller for displaying a tree representation;
a module for identifying decision points in the tree representation; and
a module for displaying a first visual indicator near decision points in the tree representation.

19. The data processing system as claimed in claim 18, wherein said module for identifying decision points in said tree representation includes a module for identifying nodes in said tree representation having an explicit user defined setting.

20. The data processing system as claimed in claim 19, further comprising:
a module for determining the status of said first node setting; and
a module for displaying a second visual indicator corresponding to the status of said first node setting.

21. The data processing system as claimed in claim 20, further comprising:
a module for determining the value of said second node setting; and
a module for displaying a third visual indicator corresponding to the value of said second node setting.

22. The data processing system as claimed claims 18, wherein said plurality of nodes are arranged in a hierarchical structure, said hierarchical structure comprising a plurality of levels including at least one parent level and at least one child level, wherein said hierarchical structure includes a node setting inheritance scheme, and wherein a node in said one child level inherits the node settings of a node in said one parent level.

23. The data processing system as claimed in claim 22, wherein said inherited settings can be overridden by an explicit setting defined by a user of the data processing system.

24. A computer data signal embodied in a carrier wave for directing a data processing system to manage a tree representation in a graphical user interface, the tree representation comprising a plurality of nodes, each node having a first and second node setting, the data processing system being operatively coupled to a display, said computer data signal comprising code for:
displaying a tree representation;
identifying decision points in the tree representation; and
displaying a first visual indicator near decision points in the tree representation.
